(19) United States
(12) Patent Application Publication
(10) Pub. No.: US 2024/0357977 A1
(43) Pub. Date: Oct. 31, 2024

(54) LAWN RAKE TONGS

(71) Applicant: Timothy O' Neal, North Canton, OH (US)

(72) Inventor: Timothy O' Neal, North Canton, OH (US)

(21) Appl. No.: 18/138,799

(22) Filed: Apr. 25, 2023

(51) Int. Cl. A01G 20/43; A01D 7/00

(52) U.S. Cl. CPC A01G 20/43; A01D 7/00

(57) ABSTRACT

A raking system for clamping a pile of yard waste between a pair of rakes to move the pile to a selected location includes a pair of pivotally interconnected sleeves which are configured to receive handles of a pair of rakes therein such that tool heads of the rakes are movable toward each other to clamp a pile of yard waste. A method of operating the raking system to move yard waste is also disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to raking systems and more particularly pertains to a new raking system for clamping a pile of yard waste between a pair of rakes to move the pile to a selected location.

### (2) Description of Related Art Including Information Disclosed Under 37 CFR 1.97 and 1.98

The prior art discloses raking systems which clamp leaves or other yard waste to move the yard waste to a new location. Some such raking systems of the prior art include rake tool heads which pivot with respect to each other to clamp the yard waste. Some raking systems with pivoting rake tool heads include elongated handles connected to the rake tool heads which pivot with respect to each other. However, the prior art fails to describe a raking system which includes a pair of pivotally interconnected sleeves that fit over handles of conventional lawn rakes, enabling the lawn rakes to be pivoted with respect to each other to clamp the yard waste. Such sleeves could be fitted onto handles of different shapes and sizes, and the positions of the sleeves on the handles could be adjusted to align the lawn rakes. These desirable functions are not achievable by the systems currently disclosed by the prior art.

### BRIEF SUMMARY OF THE INVENTION

An embodiment of the disclosure meets the needs presented above by generally comprising a first sleeve and a second sleeve which are pivotally interconnected such that the first sleeve rotates in a first plane and the second sleeve rotates in a second plane that is parallel to and spaced from the first plane. A first rake comprises a first handle and a first tool head. The first tool head is coupled to an end of the first handle and has a plurality of first tines extending away from the first handle. The first sleeve receives the first handle therein. A second rake comprises a second handle and a second tool head. The second tool head is coupled to an end of the second handle and has a plurality of second tines extending away from the second handle. The second sleeve receives the second handle therein. The first and second tool heads are moved toward each other when a distal portion of the first handle with respect to the first tool head and a distal portion of the second handle with respect to the second tool head are moved toward each other.

Another embodiment of the disclosure includes a method of moving yard waste comprising inserting a first handle of a first rake into a first sleeve and inserting a second handle of a second rake into a second sleeve. The second sleeve is pivotally coupled to the first sleeve such that each of the first and second sleeves are rotatable about a shared rotational axis with respect to each other. The first sleeve is positioned in a first selected position on the first handle, and the second sleeve is positioned in a second selected position on the second handle such that the first rake is pivotable with respect to the second rake to move a first tool head of the first rake alternately toward and away from a second tool head of the second rake. The first and second sleeves may be retained in the first and second selected positions once positioned therein, and such retention may be facilitated by frictional engagement between the first sleeve and the first handle and between the second sleeve and the second handle.

The first tool head is positioned opposite the second tool head across a pile of yard waste. A distal portion of the first handle with respect to the first tool head is moved toward a distal portion of the second handle with respect to the second tool head, thereby grasping the pile between the first and second tool heads. This movement may be performed by a coupler which couples the first sleeve to the second sleeve and is biased to pivot the first sleeve with respect to the second sleeve such that the first tool head is moved toward the second tool head. The pile is moved to a selected location by moving the first and second rakes. The distal portion of the first handle is moved away from the distal portion of the second handle to move the first and second tool heads apart, thereby releasing the pile.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a first sleeve and a second sleeve of a raking system according to an embodiment of the disclosure.

FIG. 2 is a front view of the first and second sleeves of an embodiment of the disclosure.

FIG. 3 is a side view of the first and second sleeves of an embodiment of the disclosure.

FIG. 4 is a top view of the first and second sleeves of an embodiment of the disclosure.

FIG. 5 is a detail perspective view of an embodiment of the disclosure including the first and second sleeves.

FIG. 6 is a cross-section view of an embodiment of the disclosure taken from Arrows 6-6 in FIG. 5.

FIG. 7 is a perspective view of an embodiment of the disclosure.

FIG. 8 is an in-use view of an embodiment of the disclosure.

### DETAILED DESCRIPTION OF THE INVENTION

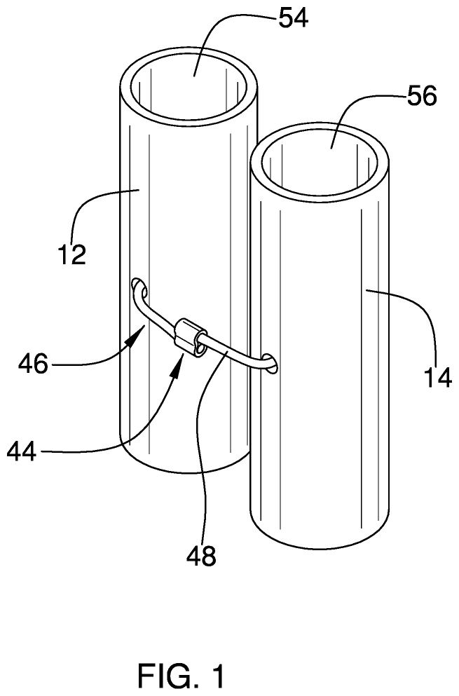

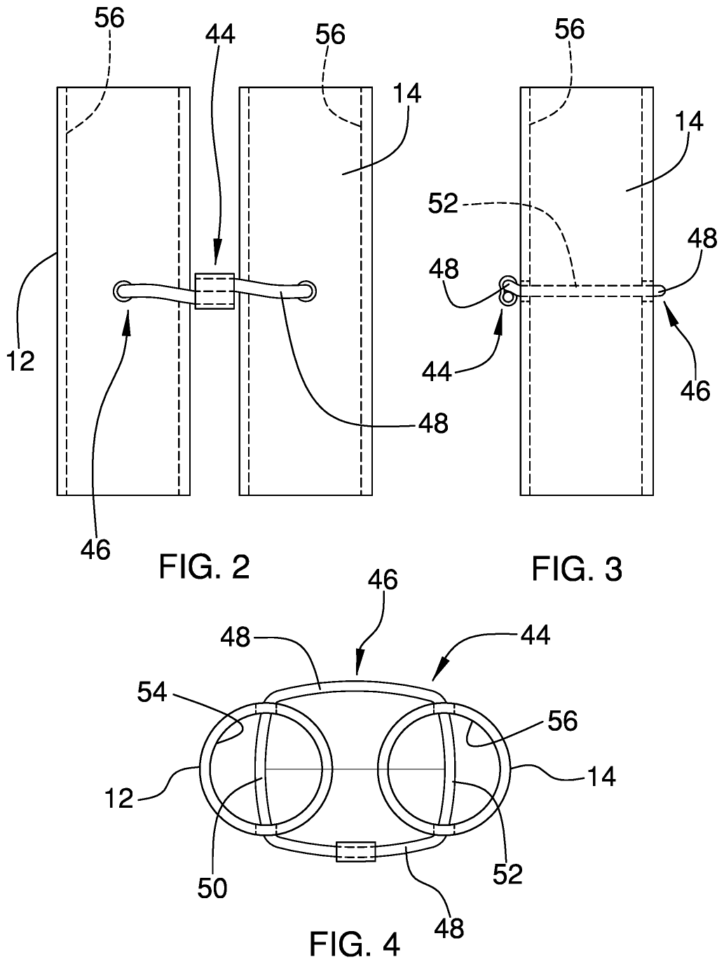

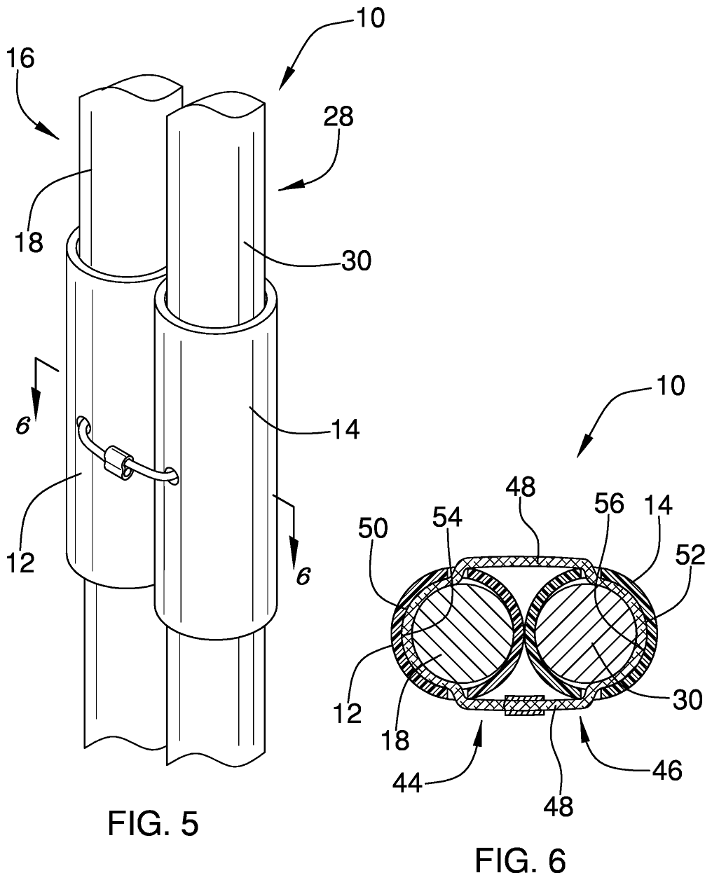

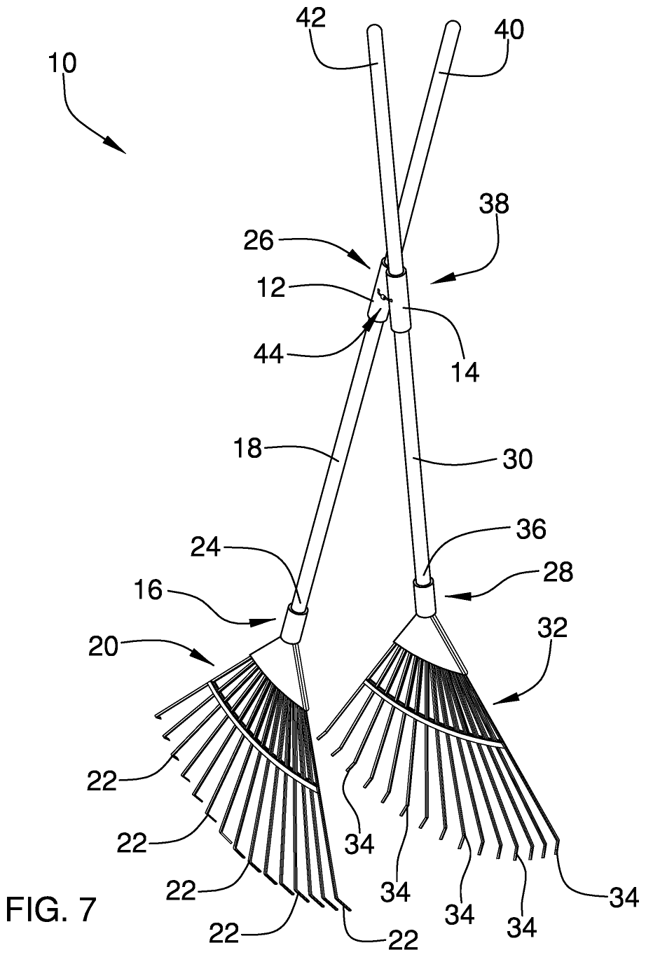

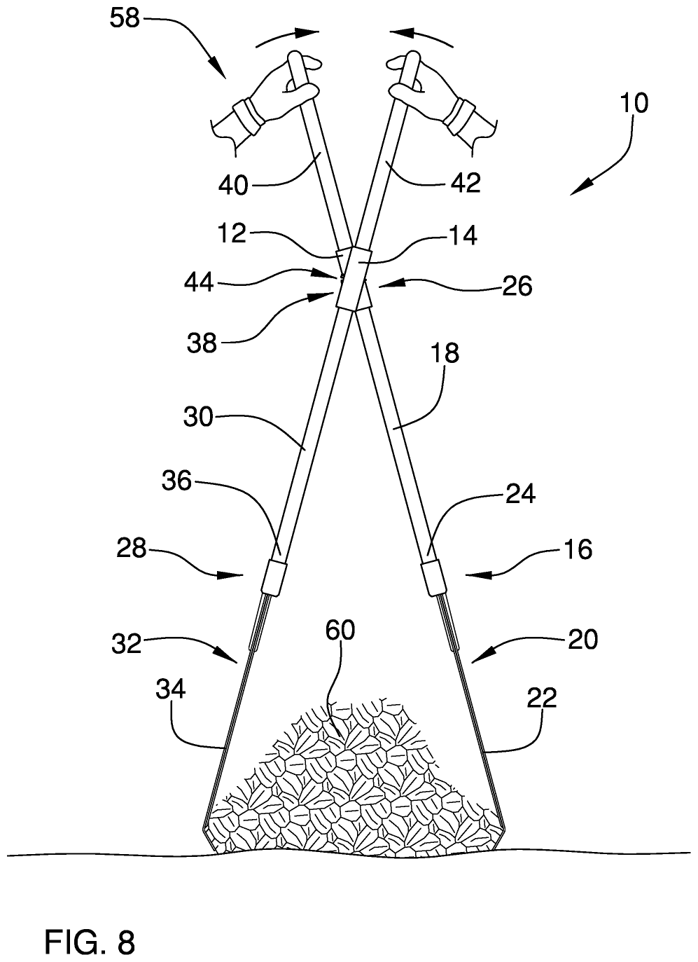

With reference now to the drawings, and in particular to FIGS. 1 through 8 thereof, a new raking system embodying the principles and concepts of an embodiment of the disclosure and generally designated by the reference numeral 10 will be described.

As best illustrated in FIGS. 1 through 8, the raking system 10 generally comprises a first sleeve 12 and a second sleeve 14 which are pivotally interconnected such that the first sleeve 12 rotates in a first plane and the second sleeve 14 rotates in a second plane which is parallel to and spaced from the first plane. A longitudinal axis of the first sleeve 12 lies on the first plane, and a longitudinal axis of the second sleeve 14 lies on the second plane.

A first rake 16 comprises a first handle 18 and a first tool head 20. The first sleeve 12 receives the first handle 18 therein. The first tool head 20 is coupled to an end 22 of the first handle 18 and has a plurality of first tines 24 extending away from the first handle 18. The plurality of first tines 24 fans outwardly from the end 22 of the first handle 18. The first sleeve 12 is slidable along the first handle 18, and the first rake 16 frictionally engages the first sleeve 12 to retain the first sleeve 12 in a first selected position 26 on the first handle 18.

A second rake 28 comprises a second handle 30 and a second tool head 32. The second sleeve 14 receives the second handle 30 therein. The second tool head 32 is coupled to an end 36 of the second handle 30 and has a plurality of second tines 34 extending away from the second handle 30. The plurality of second tines 34 fans outwardly from the end 36 of the second handle 30. The second sleeve 14 is slidable along the second handle 30, and the second rake 28 frictionally engages the second sleeve 14 to retain the second sleeve 14 in a second selected position 38 on the second handle 30.

The first and second tool heads 20, 32 are moved toward each other when a distal portion 40 of the first handle 18 with respect to the first tool head 20 and a distal portion 42 of the second handle 30 with respect to the second tool head 32 are moved toward each other. The first and second sleeves 12, 14 may be retainable via alternate means such as latches, locking pins, snap fits, or the like.

A coupler 44 connects the first and second sleeves 12, 14 together to allow the first and second sleeves 12, 14 to pivot relative to each other. The coupler 44 comprises a cord 46 having a pair of connecting portions 48 which engage and extend between the first and second sleeves 12, 14 to retain the first and second sleeves 12, 14 in abutment with each other. The pair of connecting portions 48 is resiliently stretchable, and each connecting portion 48 is stretched when first and second tool heads 20, 32 are pivoted away from each other such that the first and second tool heads 20, 32 are biased toward each other.

The cord 46 includes a first interior portion 50 which extends between the pair of connecting portions 48 and laterally through the first sleeve 12. The coupler 44 also includes a second interior portion 52 which extends between the pair of connecting portions 48 and laterally through the second sleeve 14. The first interior portion 50 is positioned between and frictionally engages the first handle 18 and an interior surface 54 of the first sleeve 12. The second interior portion 52 is positioned between and frictionally engages the second handle 30 and an interior surface 56 of the second sleeve 14.

In use, a user 58 grasps the distal portion 40 of the first handle 18 and the distal portion 42 of the second handle 30 and separates them to pivot the first tool head 20 and the second tool head 32 away from each other. The user 58 positions the first and second tool heads 20, 32 opposite each other across a pile 60 of yard waste. Then the user 58 moves the distal portions 40, 42 of the first and second handles 18, 30 toward each other to pivot the first and second tool heads 20, 32 toward each other, clamping the pile 60. The user 58 moves the pile 60 to a selected location and releases the pile 60 by again separating the distal portions 40, 42 of the first and second handles 18, 30. The first and second tool heads 20, 32 thereby separate, releasing the pile 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A raking system for grasping and moving yard waste, the system comprising:
a first sleeve and a second sleeve, the first and second sleeves being pivotally interconnected such that the first sleeve rotates in a first plane and the second sleeve rotates in a second plane which is parallel to and spaced from the first plane;
a first rake comprising a first handle and a first tool head, the first tool head being coupled to an end of the first handle and having a plurality of first tines extending away from the first handle, the first sleeve receiving the first handle therein;
a second rake comprising a second handle and a second tool head, the second sleeve receiving the second handle therein, the second tool head being coupled to an end of the second handle and having a plurality of second tines extending away from the second handle; and
wherein the first and second tool heads are moved toward each other when a distal portion of the first handle with respect to the first tool head and a distal portion of the second handle with respect to the second tool head are moved toward each other.

2. The system of claim 1, wherein a longitudinal axis of the first sleeve lies on the first plane, a longitudinal axis of the second sleeve lying on the second plane.

3. The system of claim 1, wherein the first sleeve is slidable along the first handle, the second sleeve being slidable along the second handle.

4. The system of claim 1, wherein the plurality of first tines fans outwardly from the end of the first handle, the plurality of second tines fanning outwardly from the end of the second handle.

5. The system of claim 1, wherein the first rake frictionally engages the first sleeve to retain the first sleeve in a first selected position on the first handle, the second rake frictionally engaging the second sleeve to retain the second sleeve in a second selected position on the second handle.

6. The system of claim 1, further comprising a coupler connecting the first and second sleeves together to allow the first and second sleeves to pivot relative to each other.

7. The system of claim 6, wherein the coupler comprises a cord having a pair of connecting portions which engage and extend between the first and second sleeves to retain the first and second sleeves in abutment with each other, the pair of connecting portions being resiliently stretchable, each connecting portion being stretched when first and second tool heads are pivoted away from each other such that the first and second tool heads are biased toward each other.

8. The system of claim 7, wherein the cord includes a first interior portion extending between the pair of connecting portions and laterally through the first sleeve, the cord including a second interior portion extending between the pair of connecting portions and laterally through the second sleeve.

9. The system of claim 8, wherein the first interior portion is positioned between and frictionally engages the first handle and an interior surface of the first sleeve, the second interior portion being positioned between and frictionally engaging the second handle and an interior surface of the second sleeve.

10. A raking system for grasping and moving yard waste, the system comprising:
a first sleeve and a second sleeve, the first and second sleeves being pivotally interconnected such that the first sleeve rotates in a first plane and the second sleeve rotates in a second plane which is parallel to and spaced from the first plane, a longitudinal axis of the first sleeve lying on the first plane, a longitudinal axis of the second sleeve lying on the second plane;
a first rake comprising a first handle and a first tool head, the first sleeve receiving the first handle therein, the first tool head being coupled to an end of the first handle and having a plurality of first tines extending away from the first handle, the first sleeve being slidable along the first handle, the plurality of first tines fanning outwardly from the end of the first handle, the first rake frictionally engaging the first sleeve to retain the first sleeve in a first selected position on the first handle;
a second rake comprising a second handle and a second tool head, the second sleeve receiving the second handle therein, the second tool head being coupled to an end of the second handle and having a plurality of second tines extending away from the second handle, the second sleeve being slidable along the second handle, the plurality of second tines fanning outwardly from the end of the second handle, the second rake frictionally engaging the second sleeve to retain the second sleeve in a second selected position on the second handle;
wherein the first and second tool heads are moved toward each other when a distal portion of the first handle with respect to the first tool head and a distal portion of the second handle with respect to the second tool head are moved toward each other;
a coupler connecting the first and second sleeves together to allow the first and second sleeves to pivot relative to each other, the coupler comprising a cord having a pair of connecting portions which engage and extend between the first and second sleeves to retain the first and second sleeves in abutment with each other, the pair of connecting portions being resiliently stretchable, each connecting portion being stretched when first and second tool heads are pivoted away from each other such that the first and second tool heads are biased toward each other, the cord including a first interior portion extending between the pair of connecting portions and laterally through the first sleeve, the cord including a second interior portion extending between the pair of connecting portions and laterally through the second sleeve, the first interior portion being positioned between and frictionally engaging the first handle and an interior surface of the first sleeve, the second interior portion being positioned between and frictionally engaging the second handle and an interior surface of the second sleeve.

11. A method of moving yard waste comprising:
inserting a first handle of a first rake into a first sleeve;
inserting a second handle of a second rake into a second sleeve, wherein the second sleeve is pivotally coupled to the first sleeve such that each of the first and second sleeves are rotatable about a shared rotational axis with respect to each other;
positioning the first sleeve in a first selected position on the first handle and the second sleeve in a second selected position on the second handle such that the first rake is pivotable with respect to the second rake to move a first tool head of the first rake alternately toward and away from a second tool head of the second rake;
positioning the first tool head opposite the second tool head across a pile of yard waste;
moving a distal portion of the first handle with respect to the first tool head toward a distal portion of the second handle with respect to the second tool head to pivot the first tool head toward the second tool head, thereby grasping the pile between the first tool head and the second tool head;
moving the pile to a selected location; and
moving the distal portion of the first handle away from the distal portion of the second handle to pivot the first tool head away from the second tool head, thereby releasing the pile.

12. The method of claim 11, wherein the step of moving the distal portion of the first handle toward the distal portion of the second handle is performed at least in part by a coupler which couples the first sleeve to the second sleeve and is biased to pivot the first sleeve with respect to the second sleeve such that the first tool head is moved toward the second tool head.

13. The method of claim 11, further comprising retaining the first sleeve in the first selected position and the second sleeve in the selected position after positioning the first and second sleeves therein.

14. The method of claim 13, wherein the step of retaining the first sleeve in the first selected position and the second sleeve in the second selected position includes retaining the first and second sleeves via frictional engagement with the first and second handles respectively.
